(19) United States
(12) Patent Application Publication
(10) Pub. No.: US 2019/0155479 A1
(43) Pub. Date: May 23, 2019

(54) METHODS AND SYSTEMS FOR INTEGRATED FORCE TOUCH SOLUTIONS

(71) Applicant: MaxLinear, Inc., Carlsbad, CA (US)

(72) Inventor: Curtis Ling, Carlsbad, CA (US)

(21) Appl. No.: 16/194,322

(22) Filed: Nov. 17, 2018

Related U.S. Application Data
(60) Provisional application No. 62/587,999, filed on Nov. 17, 2017.

(51) Int. Cl. G06F 3/0488; G06F 3/041

(52) U.S. Cl. CPC G06F 3/0488; G06F 3/0416; G06F 3/0414

(57) ABSTRACT

Systems and methods are provided for integrated force touch solutions. An integrated force touch chip may be implemented on a single integrated circuit die, and may comprise a sensor circuit configured for generating sensory analog signals in response to application of force against an area associated with the integrated force touch chip, and one or more circuits configured for processing signals and/or data corresponding to the sensory analog signals generated via the sensor circuit. A plurality of integrated force touch chips may be configured for use in a device or a system. One integrated force touch chip from the plurality of chips may be configured as to operate as a master with one or more other chips being configured to operate as slave(s).

### CLAIM OF PRIORITY

This patent application makes reference to, claims priority to and claims benefit from U.S. Provisional Patent Application Ser. No. 62/587,999, filed on Nov. 17, 2017. The above identified application is hereby incorporated herein by reference in its entirety.

### TECHNICAL FIELD

Aspects of the present disclosure relate to electronics devices and solutions relating thereto. More specifically, certain implementations in accordance with present disclosure relate to methods and systems for integrated force touch solutions.

### BACKGROUND

Various issues may exist with conventional approaches for designing and implementing force touch solutions. In this regard, conventional systems and methods, if any existed, for designing and implementing integrated force touch, can be costly, inefficient, and/or ineffective.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for a methods and systems for integrated force touch solutions, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates an example electronic device that may utilize force touch sensors.

FIG. 2 illustrates example conventional force touch (FT) architecture.

FIG. 3 illustrates example integrated force touch (FT) architecture, in accordance with the present disclosure.

FIG. 4 illustrates example timing charts for a conventional force touch (FT) architecture, and an integrated force touch (FT) architecture in accordance with the present disclosure.

FIG. 5 illustrates example integrated force touch (FT) architecture based multi-sensor configuration, in accordance with the present disclosure.

FIG. 6 illustrates an example structure and floorplan in a device incorporating integrated force touch (FT) architecture, in accordance with the present disclosure.

### DETAILED DESCRIPTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

An example integrated force touch chip in accordance with the present disclosure may be implemented on a single integrated circuit die, and may comprise a sensor circuit configured to generate sensory analog signals in response to application of force against an area associated with the integrated force touch chip, one or more analog signal processing circuits that may be configured to apply one or more signal processing functions to analog signals, and one or more digital signal processing circuits that may be configured to apply one or more digital signal processing functions.

In an example implementation, the one or more analog signal processing circuits may comprise a variable-gain amplifier (VGA) circuit configured to apply amplification to analog signals corresponding to the sensory analog signals generated via the sensor circuit.

In an example implementation, the one or more analog signal processing circuits may comprise an offset removal circuit configured to control or adjust the amplification applied via the variable-gain amplifier (VGA) circuit.

In an example implementation, the one or more analog signal processing circuits may comprise at least one filtering circuit configured to apply filtering to analog signals corresponding to the sensory analog signals generated via the sensor circuit. The at least one filtering circuit may comprise a low-pass filter (LPF) circuit or an anti-aliasing filter (AAF) circuit.

In an example implementation, the one or more analog signal processing circuits may comprise an analog-to-digital converter (ADC) circuit configured to apply analog-to-digital conversion to analog signals corresponding to the sensory analog signals generated via the sensor circuit.

In an example implementation, the one or more digital signal processing circuits may be configured to process an output of the analog-to-digital converter (ADC) circuit.

In an example implementation, the integrated force touch chip may comprise a common backbone circuit configured to provide or support one or more common control related functions in the integrated force touch chip. The common backbone circuit may be configured to provide common biasing, common calibrating and/or common interfacing to one or more other circuits in the integrated force touch chip.

In an example implementation, the common backbone circuit may be configured to provide interfacing to one or more other integrated force touch chips.

In an example implementation, the common backbone circuit may be configured to support Inter-Integrated Circuit (I²C) based communications.

In an example implementation, the integrated force touch chip may comprise a local main processing circuit configured to process sensory data corresponding to the sensory analog signals generated via the sensor circuit.

In an example implementation, the local main processing circuit may be configured to control at least one other circuit in the integrated force touch chip.

An example system in accordance with the present disclosure may comprise one or more integrated force touch chips, with each integrated force touch chip being implemented on a single integrated circuit die. Each integrated force touch chip may comprise a sensor circuit configured to generate sensory analog signals in response to application of force against an area associated with the integrated force touch chip, and one or more signal processing circuits configured to apply one or more signal processing functions to signals corresponding to the sensory analog signals generated via the sensor circuit.

In an example implementation, each integrated force touch chip may comprise an interfacing circuit configured to provide interfacing to one or more other integrated force touch chips.

In an example implementation, the interfacing circuit may be configured to support Inter-Integrated Circuit (I²C) based communications.

In an example implementation, at least one integrated force touch chip may be configured as a master, with one or more other integrated force touch chip being configured as slaves of the at least one integrated force touch chip.

In an example implementation, the at least one integrated force touch chip configured as a master may be configured to process data from the one or more other integrated force touch chip configured as slaves.

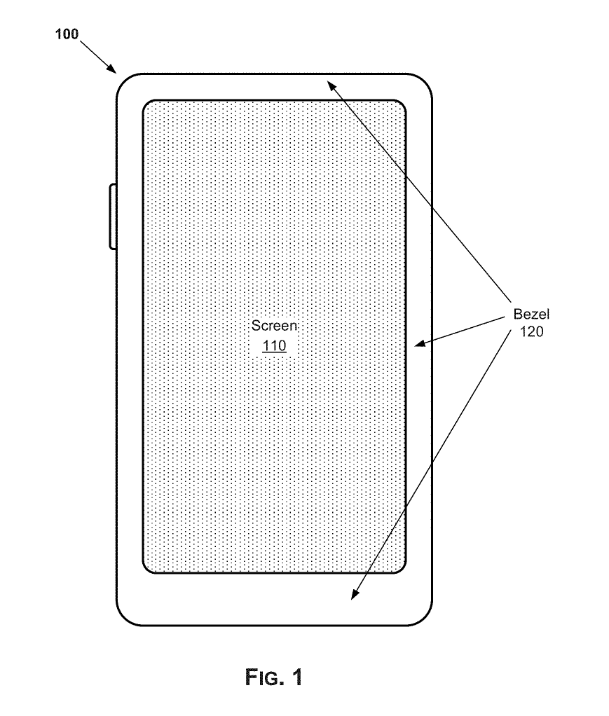

FIG. 1 illustrates an example electronic device that may utilize force touch sensors. Shown in FIG. 1 is an electronic device 100.

The electronic device 100 may comprise suitable circuitry for performing various functions or operations, and/or run various applications and/or programs. In this regard, operations, functions, applications and/or programs supported by the electronic device 100 may be performed, executed and/or run based on user instructions and/or pre-configured instructions. Examples of electronic devices may comprise handheld mobile devices (e.g., cellular phones, smartphones, and/or tablets), computers (e.g., laptops, desktop or personal computers, and/or servers), etc. The disclosure, however, is not limited to any particular type of electronic device.

The electronic device 100 may incorporate components or subsystems for generating and/or obtaining certain information. For example, the electronic device 100 may comprise dedicated components enabling interactions with users, such as obtaining user input and/or providing user output.

In some implementations, electronic devices (such as the electronic device 100) may be configured for receiving touch-based user input—that is, input that is provided by means of the user interacting with the electronic devices by touching the electronic devices or component thereof in particular way. In this regard, the electronic devices may incorporate sensory means for detecting forces applied by the user, and then process the corresponding sensory data in order to interpret user's interactions—e.g., to determine what (if any) input the user is attempting to provide.

For example, electronic devices such as smartphones, tablets, and (some) laptop computers may incorporate a screen (e.g., screen 110 in the electronic device 100) that may be configured as a touchscreen—that is, configured to receive input based on user interactions with the screen. Examples of possible types of input that may be provided via the screen 110 may include tapping, pressing, sliding, etc. The combination of the form of the interaction and the particular region where the interaction is made may be used when determining whether (or not) the user is attempting to provide a particular input, and how to interpret such input.

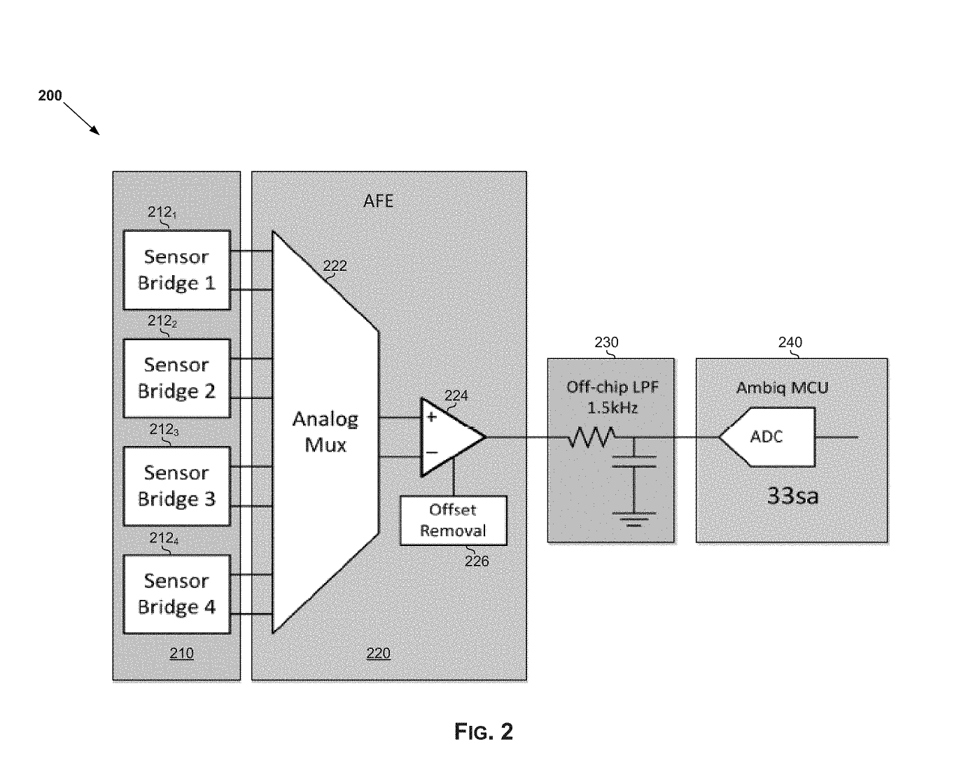

In some instances, electronic devices may be configured to also support receiving touch-based user input applied to areas other than the screen—e.g., a smartphone's “bezel” which typically includes all of the non-screen space on the front or side of the phone. For example, bezel 120 in the electronic device 110 may incorporate force touch based sensory components embedded therein, which may be configured to detect when the user applies force into the bezel 120, and generate corresponding sensory data. The sensory data may then be processed, to determine if it constitutes intended user input or not—for example, based on thresholds to differentiate between normal forces (e.g., forces applied when holding the electronic device) and forces intended as user input. An example conventional touch-force architecture is shown in FIG. 2.

FIG. 2 illustrates an example conventional force touch (FT) architecture. Shown in FIG. 2 is force touch (FT) architecture 200.

The FT architecture 200 (or portion thereof shown in FIG. 2) comprises a plurality of sensor bridge circuits 212 (e.g., 4 sensor bridge circuits 212₁, 212₂, 212₃, and 212₄ as shown in FIG. 2) embedded within a bezel 210, an analog-front-end (AFE) circuit 220 (e.g., one for each set of bridge circuits, such as 4 bridge circuits as shown in FIG. 2), a low-pass filter (LPF) circuit 230, and a memory controller unit (MCU) circuit 240. The AFE circuit 220 may comprise an analog multiplexer (MUX) 222 that selects between inputs from the corresponding bridge circuits—thus, in the example implementation shown in FIG. 2, the MUX 222 is a 4-to-1 selector. The AFE circuit 220 also comprises a variable-gain amplifier (VGA) 224 and offset removal circuit 226, which may be used to generate a sensory signal based on the difference between each two pins in one of the bridge circuits—the one selected via the MUX 222. After filtering via the LPF circuit 230, the sensory signal may be digitized via an analog-to-digital convertor (ADC) 242 in the MCU circuit 240.

As shown in FIG. 2, in conventional solutions the force touch architecture is implemented using separate and distinct circuits (e.g., on separate die), and the architecture has timing constraints as it is typically configured for assessing separately each of a number of sensor bridge circuits that are assigned to a single AFE circuit.

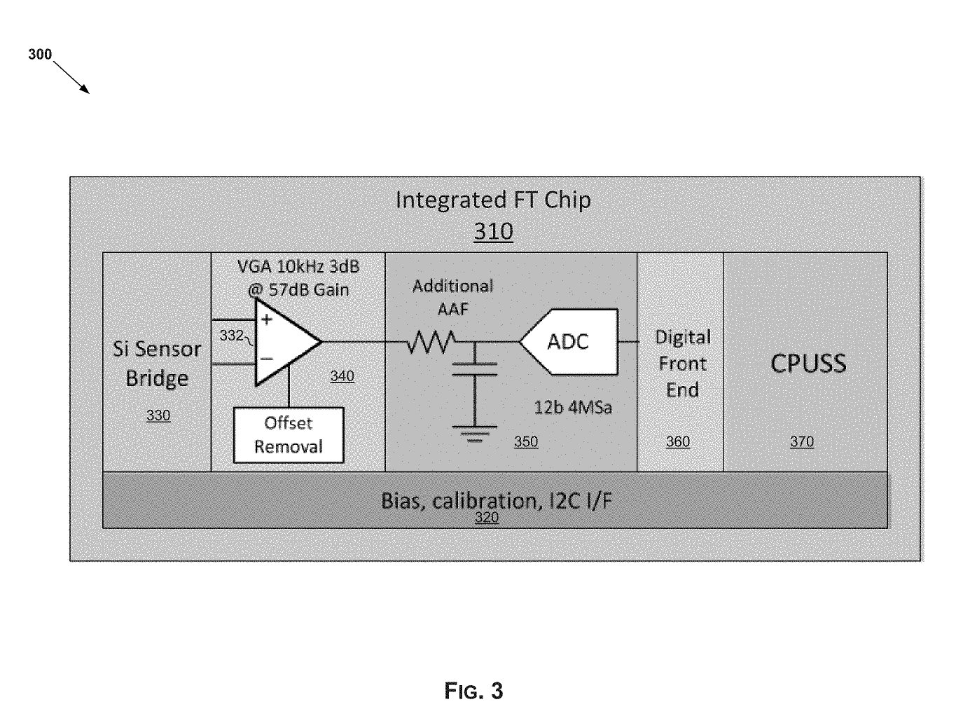

Accordingly, in various implementations in accordance with the present disclosure, an enhanced force touch architecture may be used to overcome some of the possible issues with the conventional solutions, particularly with respect to the delays and costs. For example, the enhanced force touch architecture may be designed for implementation on a single integrated circuit die (or chip) that combines the sensory function (e.g., corresponding to each of the sensor bridge circuits 212 in FIG. 2) with the required processing functions. An example enhanced, integrated based architecture is described with respect to FIG. 3.

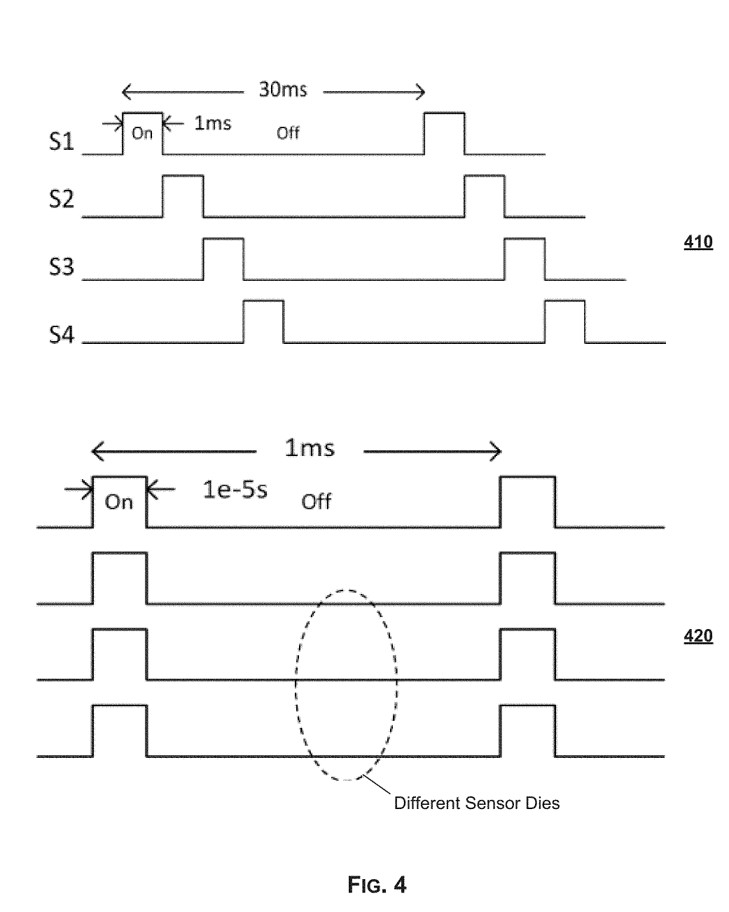

Use of such integrated architecture may result in a substantial reduction in costs and complexity. Further, the enhanced force touch architecture may be configured for concurrent operation of sensor bridges, since each die incorporates the sensor bridge function and its required processing functions, thus reducing unnecessary delays—this is illustrated in FIG. 4.

FIG. 3 illustrates example integrated force touch (FT) architecture, in accordance with the present disclosure. Shown in FIG. 3 is force touch (FT) architecture 300.

The FT architecture 300 (or portion thereof shown in FIG. 2) comprises an integrated force touch chip 310. In this regard, the integrated force touch chip 310 comprises suitably circuitry for providing the sensor bridge function and all related processing functions, with that circuitry incorporated on single integrated circuit die. For example, as shown in FIG. 3, the integrated force touch chip 310 comprises a common backbone 320, a sensor bridge 330, an analog signal adjuster 340, a signal converter 350, a digital-front-end (DFE) 360, and a local central processing unit (CPUSS) 370.

The common backbone 320 may be configured for providing such functions within the chip as biasing, calibrating, and bus/interfacing, such as in accordance with I²C (Inter-Integrated Circuit) interface.

The sensor bridge 330 may be configured for generating sensory-based analog signals—e.g., in response to application of force into the integrated force touch chip 310 (or an area of the FT architecture 300 or a device comprising the FT architecture 300 that corresponds to the integrated force touch chip 310.

The analog signal adjuster 340 may be configured for performing initial adjustments to analog signals generated via the sensor bridge 330. For example, the analog signal adjuster 340 may comprise a variable-gain amplifier (VGA), for applying amplification, and an offset removal circuit configuring for applying an offset removal adjustment to the signals, such as by controlling or adjusting the gain of the variable-gain amplifier (VGA).

The signal converter 350 may be configured for converting analog signals to digital form, and may also be configured to perform additional analog processing functions thereon before the conversion to digital form. For example, the signal converter 350 may comprise a low-pass filter (LPF) and/or an anti-aliasing filter (AAF), for applying filtering adjustments to the analog signals as outputted after processing by the analog signal adjuster 340, and an analog-to-digital converter (ADC) for applying analog-to-digital conversions.

The digital-front-end (DFE) 360 may be configured for performing digital processing and/or other functions to the sensory signals after being converted to digital form via the signal converter 350.

The local central processing unit (CPUSS) 370 may be configured for providing various local processing functions, including processing data corresponding to the signals generated by the sensor bridge 320—e.g., to compute applied forces and positions associated therewith. The local central processing unit (CPUSS) 370 may be configured for controlling other components (circuits) in the integrated force touch chip 310. Further, the local central processing unit (CPUSS) 370 may be configured for handling interactions with other chips, such as via the common backbone 320.

The FT architecture 300 may be configured for use of integrated force touch chips (such as the chip 310), with the sensor bridge functions and all related processing functions are incorporated onto single integrated circuit dies. In this regard, as noted above, with respect to FIG. 2, an integrated architecture may offer various advantages over existing and conventional architectures (such as the one shown in FIG. 2). For example, highly sensitive piezoresistor bridge may be integrated in standard complementary metal-oxide-semiconductor (CMOS). In this regard, the piezoelectric “gauge factor” may determine the sensor sensitivity or resolution.

In this regard, each integrated force touch chip 310 comprises suitably circuitry for providing the sensor bridge function and all related processing functions, with that circuitry incorporated on single integrated circuit die. In this regard, as noted above with respect to FIG. 2, an integrated architecture may offer various advantages over existing, conventional architectures (such as the one shown in FIG. 2). For example, highly sensitive piezoresistor bridge may be integrated in standard complementary metal-oxide-semiconductor (CMOS). In this regard, the piezoelectric “gauge factor” may determine the sensor sensitivity or resolution.

In particular, p-well and n-well resistors may form very sensitive piezoresistors, and low doping levels (e.g., below 1e18) may result in gauge factors significantly lower than existing sensors (e.g., gauge factors 70 to 150 versus 10 for existing sensors). Further, doping type may determine sign of coefficient, while layout orientation is critical as well. Also, temperature dependence may be easily calibrated out dynamically. In addition, positive-coefficient and negative-coefficient sensors may both be integrated on a single die.

Another advantage is that well resistors are mature passive components in standard CMOS (e.g., 0.18 μm CMOS may be used, due to maturity and lack of restriction on use of existing technologies). Also, lagging-edge processes can be used, resulting in lower cost and leakage (e.g., with 0.18 μm CMOS cost may be less than 1.5 cents per mm²). Also, High-performance/low-power ADCs (e.g., audio grade) can be integrated on the chip. Further, at 0.18 μm, a 30 k-gate MCU may occupy only about 0.35 mm² routed.

Thus, a complete force touch system can be integrated on a single die—that is, provide a full force touch (FT) system-on-chip (SoC) that includes a sensor bridge and all related components for the required functions (e.g., AFE, ADC, MCU, etc.), and may incorporate any required software/firmware. Use of such single die system may result in significant cost, power, and performance improvements over existing/conventional solutions.

Integration of all these function into single die eliminates third party sensors and MCUs while simplifying manufacture, may provide dramatically improved duty cycled power, and may improve signal path sensitivity. The integrated architecture may also allow for and support other uses that may not be possible (or optimal) with existing architecture. Such other uses may include handling and gesture detection across entire phone case. In this regard, array processing of sensor data may allow for triangulating sources of vibration and contact.

FIG. 4 illustrates example timing charts for conventional force touch (FT) architecture, and integrated force touch (FT) architecture in accordance with the present disclosure. Shown in FIG. 4 are timing charts 410 and 420.

The timing charts 410 and 420 correspond to example use scenarios of a convention force touch architecture (e.g., the force touch architecture 200 of FIG. 2) and an integrated force touch architecture in accordance with the present disclosure (e.g., the integrated force touch architecture 300 of FIG. 2).

As shown in timing chart 410, active operation of the sensor bridge circuits are staggered since as multiple ones of these circuits share a single processing path. For example, as illustrated in chart 410 with reference to the force touch architecture 200 of FIG. 2, each of the sensor bridge circuits 212₁-212₄ has a cycle of 30 ms, being activated (on), by selecting it via the MUX 222 in the AEF circuit 220, for only 1 ms, and is then deactivated (off) for 29 ms. Further, each sensor bridge circuit activates only after another is deactivated.

In this regard, staggering the activation sensor bridge circuits is required as only one of them can be selected at any given point via the MUX 222. Further, the lengthy off time in the on/off cycle is required to ensure that processing of signals from all four sensor bridge circuits is completed before re-activating again.

As shown in timing chart 420, however, the bridge sensors may be handled concurrently and independently, as each integrated force touch die incorporate a single bridge sensor and all related processing functions. Further, because all these functions reside on single chip (die), capturing sensory signals and processing of these signals may be done faster. For example, as shown in timing chart 420, each bridge sensor may be activated for only 0.01 ms, and the on/off cycle may have a duration of only 1 ms as processing can be done quickly.

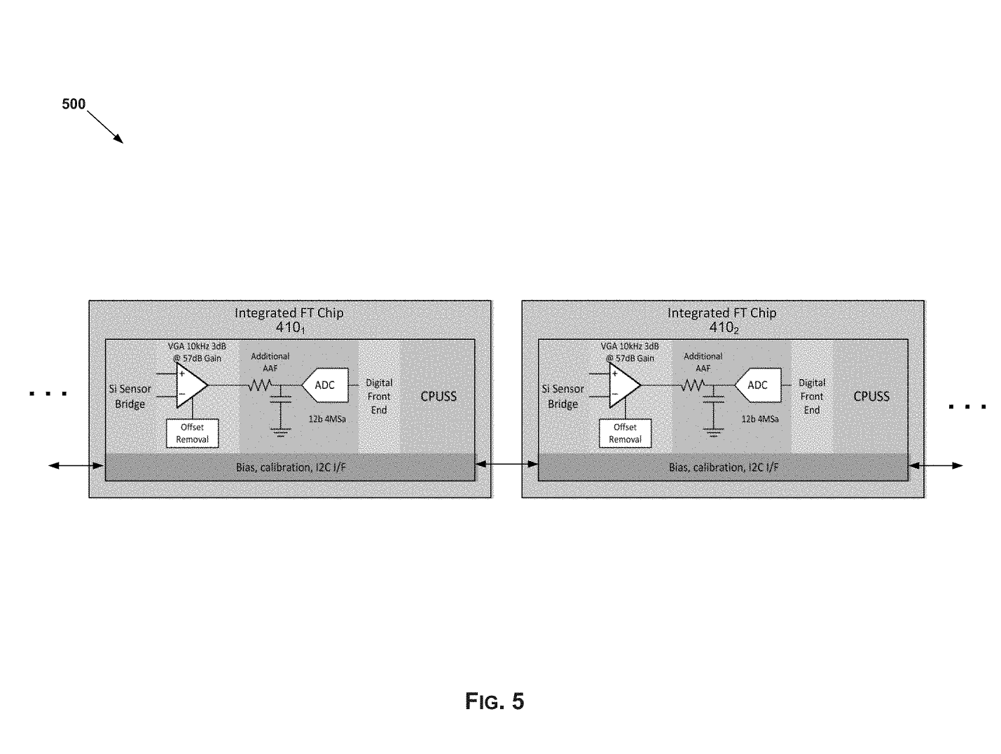

FIG. 5 illustrates example integrated force touch (FT) architecture based multi-sensor configuration, in accordance with the present disclosure. Shown in FIG. 5 is an arrangement 500 using a plurality of integrated force touch chips 510₁ (of which, chips 510₁ and 510₂ are shown).

Each of the chips 510₁ may be substantially similar to the integrated force touch chip 310 described in FIG. 3, for example. As shown in FIG. 5, in an example implementation, integrated force touch chips in accordance with the present disclosure may be configurable to support multi-sensor arrangement, like the arrangement 500. In this regard, the multiple sensor chips may be daisy-chained, using the common backbone components therein—e.g., I²C bus/interface based connections, with one of the chips (e.g., chip 510₁ in FIG. 5) being designated a master, with the remaining chips being slaves. The master chip may handle data from each sensor—e.g., to compute applied forces and position.

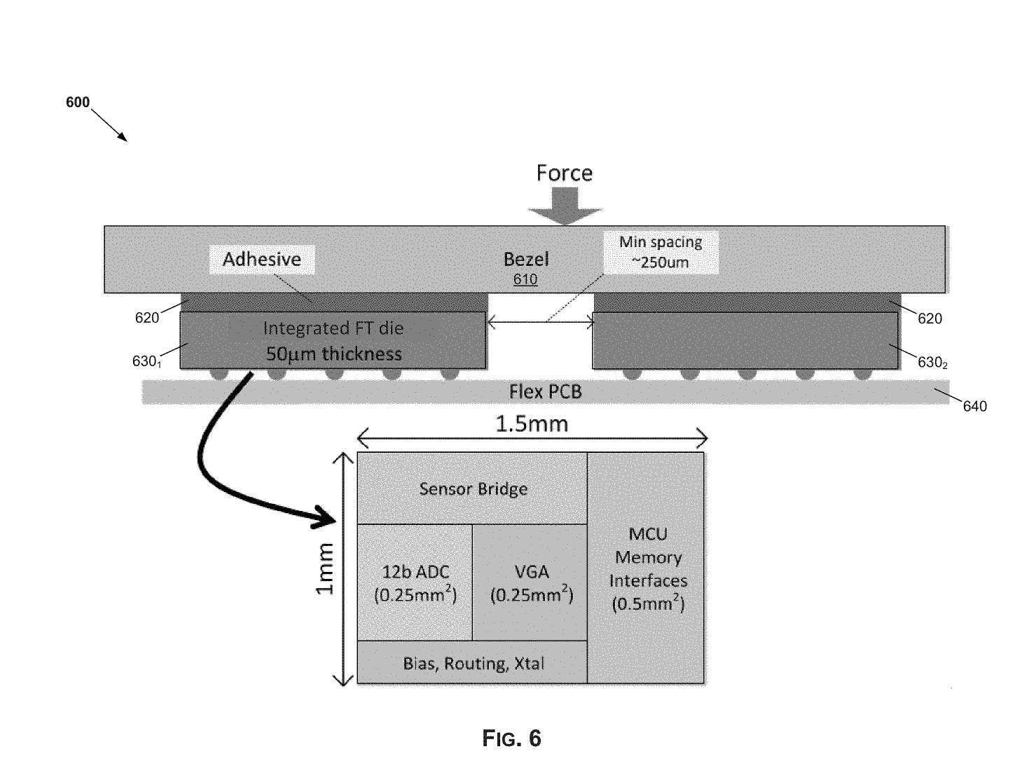

FIG. 6 illustrates an example structure and floorplan in a device incorporating integrated force touch (FT) architecture, in accordance with the present disclosure. Shown in FIG. 6 is an example floorplan 600 incorporating integrated force touch die.

The floorplan 600 may be within an electronic device (e.g., electronic device 100 of FIG. 1) configured or implemented using the proposed integrated force touch (FT) architecture. As shown in FIG. 6, integrated force touch (FT) die 630₁ (of which die 630₁ and 630₂ are shown) may be incorporated below the bezel layer 610, being attached to it via adhesive 620. The spacing between adjacent FT die 630₁ may be selected for optimal operations—e.g., at minimum 250 μm as shown in FIG. 6.

The FT die 630₁ may be designed to be as compact as possible—e.g., having thickness of 50 μm, and being 1 mm×1.5 mm. The die 630₁ may rest on top of a flexible printed circuit board (PCB) layer 640. The layout within each die 630₁ may be adaptively designed, to provide sufficient space for each element (e.g., 0.25 mm² for the ADC, 0.25 mm² for the VGA, 0.50 mm² for the MCU, etc.) while allowing the fastest possible processing path.

Accordingly, implementations in accordance with the present disclosure may provide significant improvement over existing solutions. For example, with respect to performance, power consumption may be reduced (e.g., at 2% duty cycle, allowing for ramp up/down, 8 sensors implemented in accordance with the present disclosure may consume <25 μW, with ˜150 μW always on power per sensor). Further, several operational factors may experience significant improvements.

For example, the integrated FT die based design and implementations may improve sensor gauge factor (e.g., by 7×), improve aliasing (e.g., by 3×), improve latency (e.g., by 4×), quantization (e.g., by 8×, such as due to use of 12 bit ADC, oversampling, and better line-up design), and may also allow for denser placement of sensors (e.g., by 4×) and as such result in overall improvement in sensitivity (e.g., by 100×) and spatial resolution (e.g., 10 μm). However, spatial resolution and force sensitivity may be limited by certain factors or conditions. For example, ambient spurious mechanical vibrations, device 1/f and thermal noise.

Thus, some additional techniques and measures, such as chopper stabilization and correlated double sampling, may be used. Another advantage of the proposed integrated FT die based solutions is that sensor array processing may be localized and may allow for suppressing spurious input.

In an example implementation, device usage models may be configured and/or utilized, such as to allow configuring devices or systems incorporating the proposed integrated FT die based architecture. Such models may comprise, for example, assignment of a master CPU (MCPU), program of sensor coordinates (e.g., x-y coordinates, such as in mm) of a sensor array into the MCPU, program of basic physical parameters of mounting surface into the MCPU (e.g., mechanical stiffness, thickness, etc.), assignment of wake-up/always-on to specific sensors in array, etc.

The architecture in accordance with the present disclosure may also offer significant reduction in cost (e.g., as silicon cost less, typically costing at 75% GM, which may result in cost of ˜15 cent per sensor, or $1.20 for 8 sensors). The architecture in accordance with the present disclosure also offers greatly improved sensitivity, bandwidth and resolution opens possibilities.

For example, integrated force touch based implementations may be able to better recognize where and how the phone is being handled, better detect tapping on various quadrants of phone front or back, and/or may distinguish if the phone is being driven, flown, walked, or placed on a surface. Further, the integrated force touch architecture may offer extremely low-power consumption (e.g., single button function may draw less than 5 μW. Also, the modular approach of the integrated force touch architecture in accordance with the present disclosure may accommodate a wide range of possible host device designs.

Other embodiments in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to any particular embodiment disclosed, but that the present disclosure will include all embodiments falling within the scope of the appended claims.

What is claimed is:

1. An integrated force touch chip, comprising:
a sensor circuit configured to generate sensory analog signals in response to application of force against an area associated with the integrated force touch chip;
one or more analog signal processing circuits configured to apply one or more signal processing functions to analog signals; and
one or more digital signal processing circuits configured to apply one or more digital signal processing functions;
wherein the integrated force touch chip is implemented on a single integrated circuit die.

2. The integrated force touch chip of claim 1, wherein the one or more analog signal processing circuits comprise a variable-gain amplifier (VGA) circuit configured to apply amplification to analog signals corresponding to the sensory analog signals generated via the sensor circuit.

3. The integrated force touch chip of claim 2, wherein the one or more analog signal processing circuits comprise an offset removal circuit configured to control or adjust the amplification applied via the variable-gain amplifier (VGA) circuit.

4. The integrated force touch chip of claim 1, wherein the one or more analog signal processing circuits comprise at least one filtering circuit configured to apply filtering to analog signals corresponding to the sensory analog signals generated via the sensor circuit.

5. The integrated force touch chip of claim 4, wherein the at least one filtering circuit comprises a low-pass filter (LPF) circuit.

6. The integrated force touch chip of claim 4, wherein the at least one filtering circuit comprises an anti-aliasing filter (AAF) circuit.

7. The integrated force touch chip of claim 1, wherein the one or more analog signal processing circuits comprise an analog-to-digital converter (ADC) circuit configured to apply analog-to-digital conversion to analog signals corresponding to the sensory analog signals generated via the sensor circuit.

8. The integrated force touch chip of claim 7, wherein the one or more digital signal processing circuits configured to process an output of the analog-to-digital converter (ADC) circuit.

9. The integrated force touch chip of claim 1, further comprising common backbone circuit configured to provide or support one or more common control related functions in the integrated force touch chip.

10. The integrated force touch chip of claim 9, wherein the common backbone circuit is configured to provide common biasing to one or more other circuits in the integrated force touch chip.

11. The integrated force touch chip of claim 9, wherein the common backbone circuit is configured to provide common calibrating to one or more other circuits in the integrated force touch chip.

12. The integrated force touch chip of claim 9, wherein the common backbone circuit is configured to provide common interfacing to one or more other circuits in the integrated force touch chip.

13. The integrated force touch chip of claim 9, wherein the common backbone circuit is configured to provide interfacing to one or more other integrated force touch chips.

14. The integrated force touch chip of claim 9, wherein the common backbone circuit is configured to support Inter-Integrated Circuit (I²C) based communications.

15. The integrated force touch chip of claim 1, further comprising a local main processing circuit configured to process sensory data corresponding to the sensory analog signals generated via the sensor circuit.

16. The integrated force touch chip of claim 15, wherein the local main processing circuit is configured to control at least one other circuit in the integrated force touch chip.

17. A system comprising:
one or more integrated force touch chips, wherein each integrated force touch chip is implemented on a single integrated circuit die and comprises:
a sensor circuit configured to generate sensory analog signals in response to application of force against an area associated with the integrated force touch chip; and
one or more signal processing circuits configured to apply one or more signal processing functions to signals corresponding to the sensory analog signals generated via the sensor circuit.

18. The integrated force touch chip of claim 17, wherein each integrated force touch chip comprises an interfacing circuit configured to provide interfacing to one or more other integrated force touch chips.

19. The integrated force touch chip of claim 18, wherein the interfacing circuit is configured to support Inter-Integrated Circuit (I²C) based communications.

20. The integrated force touch chip of claim 17, wherein at least one integrated force touch chip is configured as a master, with one or more other integrated force touch chip being configured as slaves of the at least one integrated force touch chip.

21. The integrated force touch chip of claim 20, wherein the at least one integrated force touch chip configured is configured to process data from the one or more other integrated force touch chip configured as slaves.
